(19) United States
(12) Patent Application Publication
(10) Pub. No.: US 2024/0225804 A9
(43) Pub. Date: Jul. 11, 2024

(54) Electric toothbrush

(71) Applicant: Chaozhou Lejiu Plastic Limited Company ., Guangdong (CN)

(72) Inventors: Liwei Cai, Shantou (CN); Qilin Chen, Suzhou (CN)

(21) Appl. No.: 17/595,085

(22) PCT Filed: Jul. 7, 2021
(86) PCT No.: PCT/CN2021/104978

§ 371 Date: Nov. 8, 2021

(30) Foreign Application Priority Data
Jun. 29, 2021 (CN) 202110726084.7

(51) Int. Cl. A61C 17/26; A61C 17/22

(52) U.S. Cl. CPC A61C 17/26; A61C 17/221

(57) ABSTRACT

The present disclosure relates to an electric toothbrush, including a shell, a toothbrush head, a first spiral bevel gear, a second spiral bevel gear, and a drive motor. The toothbrush head is connected with the second spiral bevel gear; the first spiral bevel gear and the second spiral bevel gear are in transmission connection; the first spiral bevel gear is arranged above the drive motor and is in transmission connection with the drive motor; a central axis of the first spiral bevel gear is perpendicular to a central axis of the second spiral bevel gear; and the drive motor has a stepped shaft connected to the first spiral bevel gear. The first spiral bevel gear and the second spiral bevel gear are used to drive the toothbrush head to rotate, so that the drive is steady and the transmission efficiency is high. A main shaft of the drive motor adopts the stepped shaft, which can improve the transmission efficiency, so that the transmission is steadier. Since the coupling in the existing art is simplified, noise generated in the transmission process can be reduced, disordered shake in the rotating process of the toothbrush head is reduced, the use experience of a user is enhanced, and the service life is prolonged.

### TECHNICAL FIELD

The present disclosure relates to the technical field of toothbrushes, in particular to an electric toothbrush.

### BACKGROUND

In daily life, people usually use manual toothbrushes to clean their teeth. A manual toothbrush is composed of bristles and a toothbrush rod. When the toothbrush is used to brush the teeth longitudinally, the toothbrush is cumbersome and is very hard to clean. In an existing electric toothbrush, a toothbrush head and a toothbrush body can only rotate 90 degrees, so that dirt in crevices between teeth cannot be cleaned, either. The electric toothbrush in the existing art generally has low transmission efficiency and high noise since a drive shaft and a main shaft of a motor are connected through a coupling.

### SUMMARY

The present disclosure aims to overcome the shortcomings in the existing art and provide an electric toothbrush with simple structure, steady transmission, high transmission efficiency, and low noise, in which a motor drives a first spiral bevel gear and a second spiral bevel gear to rotate, thus driving a toothbrush head to rotate 360 degrees.

Further,

The advantages are as follows:

1. The first spiral bevel gear and the second spiral bevel gear are used to drive the toothbrush head to rotate, so that the drive is steady, and the transmission efficiency is high.

2. The main shaft of the drive motor adopts a stepped shaft, which can improve the transmission efficiency, so that the transmission is steadier. Since the coupling in the existing art is simplified, noise generated in the transmission process can be reduced, disordered shake in the rotating process of the toothbrush head is reduced, the use experience of a user is enhanced, and the service life is prolonged.

3. The second shaft body in the stepped shaft is connected with the shell through a bearing, which further improves the steadiness in the transmission process and improves the transmission efficiency.

### BRIEF DESCRIPTION OF THE DRAWINGS

The specific implementation modes are further described below in combination with the accompanying drawings.

FIG. 1 is a schematic diagram of an overall structure of an electric toothbrush of the present disclosure; and

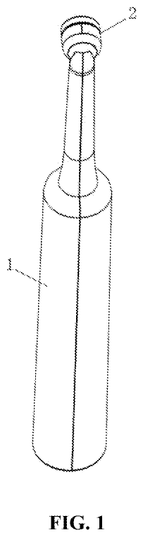

FIG. 2 is a schematic diagram of an internal structure of an electric toothbrush of the present disclosure.

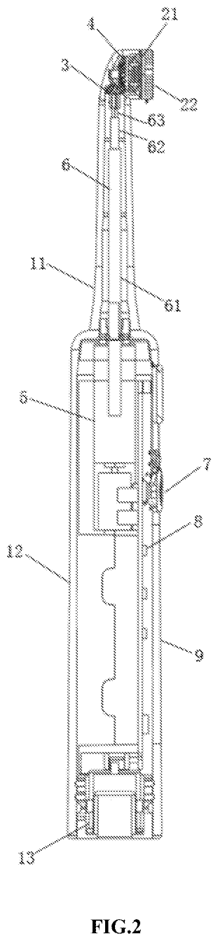

Specific structures corresponding to the reference signs are as follows: 1: shell; 11: front toothbrush handle body; 12: rear toothbrush handle body; 13: socket body; 2: toothbrush head; 21: circular mounting surface; 22: bristle; 3: first spiral bevel gear; 4: second spiral bevel gear; 5: drive motor; 6: stepped shaft; 61: first shaft body; 62: second shaft body; 63: third shaft body; 7: control button; 8: indicator lamp; 9: protection plate.

The present disclosure will be further described in the following specific implementation modes with reference to the above accompanying drawings.

### DETAILED DESCRIPTION OF THE EMBODIMENTS

An electric toothbrush in one preferred embodiment of the present disclosure includes a shell 1, a toothbrush head 2, a first spiral bevel gear 3, a second spiral bevel gear 4, and a drive motor 5. The toothbrush head 2 is connected with the second spiral bevel gear 4; the first spiral bevel gear 3 and the second spiral bevel gear 4 are in transmission connection; the first spiral bevel gear 3 is arranged above the drive motor 5 and is in transmission connection with the drive motor 5; and a central axis of the first spiral bevel gear 3 is perpendicular to a central axis of the second spiral bevel gear 4.

The drive motor 5 has a stepped shaft 6 connected to the first spiral bevel gear. The stepped shaft 6 includes a first shaft body 61, a second shaft body 62, and a third shaft body 63, the diameters of which are sequentially reduced from bottom to top. The third shaft body 63 is in transmission connection with the first spiral bevel gear 3. A bearing (not shown) connected to an inner wall of the shell 1 is arranged in the shell 1. The bearing is rotatably connected with the second shaft body 62 of the stepped shaft 6.

In the above embodiment, the shell 1 includes a front toothbrush handle body 11 and a rear toothbrush handle body 12; a front end part of the rear toothbrush handle body 12 is connected to a rear end part of the front toothbrush handle body 11; the drive motor 5 is connected to an inner wall of the rear toothbrush handle body 12; and an outer wall of the rear toothbrush handle body 12 is connected with a control button 7 for switching a rotating speed of the drive motor 5 and/or controlling the drive motor 5 to be turned on and turned off.

In the above embodiment, a lower end of the rear toothbrush handle body 12 is connected with a socket body 13, and a battery (not shown) for supplying power to the control button 7 and the drive motor 5 is arranged in the socket body 13 or the rear toothbrush handle body 12. In an actual implementation process, for the convenience of charging the battery, the socket body 13 is provided with a charging interface used for charging the battery.

In the above embodiment, the control button 7 is connected with a control chip (not shown). The control button 7 is in signal connection with the control chip. The control chip is arranged in the rear toothbrush handle body 12 or the socket body 13. The control chip is electrically connected with the battery.

In the above embodiment, the inside of the rear toothbrush handle body 12 is connected with several indicator lamps 8 for displaying gear positions of the drive motor. The indicator lamps 8 are in signal connection with the control chip and/or the control button 7. By means of the indicator lamps 8, an operation state of the electric toothbrush can be conveniently indicated so that users can conveniently adjust the rotating speed of the drive motor according to their habits, thus enhancing the experience of the users. In the actual implementation process, there are three indicator lamps 8, which correspond to three speed levels of the drive motor 5.

In the above embodiment, the outer wall of the rear toothbrush handle body 12 is connected with a protection plate 9. The height of the protection plate 9 is greater than a distance between the two indicator lamps 8 on the outermost side. The protection plate 9 is a transparent plate body. By means of setting the protection plate 9 to be the transparent plate body, the indicator lamps 8 can be protected, and the lightening of the indicator lamps 8 can be conveniently observed.

In the above embodiment, the toothbrush head 2 has a circular mounting surface 21 which is connected with multiple layers of annularly distributed bristles 22. The bristles 22 are annularly distributed on the circular mounting surface 21, which can improve the uniformity of a contact force between the bristles 22 and the teeth of a user. In the process that the toothbrush head 2 rotates, since the bristles 22 clockwise and anticlockwise rotates 360 degrees with the toothbrush head 2, dirt in crevices between teeth can be cleaned, which can make the user comfortable and does not damage the gum.

In the above embodiment, the first shaft body 61, the second shaft body 62, and the third shaft body 63 are integrated to form the stepped shaft 6. The first spiral bevel gear 3 and the second spiral bevel gear 4 are both integrated by injection molding.

In the above embodiment, the control chip is configured to be used for receiving an electric signal from the control button and switching the rotating speed of the drive motor 5 and/or controlling the drive motor 5 to be turned on and turned off. In the actual implementation process, the control chip is further configured to rotate at a low speed for 3-5 s after receiving a turn-on signal from the control button 7, and then to control the rotating speed of the drive motor 5 according to the corresponding gear position after toothpaste is fully dispersed.

The above-mentioned embodiments only express several implementation modes of the present disclosure, and their descriptions are more specific and detailed, but they cannot be understood as limiting the patent scope of the present disclosure. It should be noted that those of ordinary skill in the art can further make various transformations and improvements without departing from the concept of the disclosure, and these transformations and improvements all fall within the protection scope of the present invention. Therefore, the protection scope of the patent of the present disclosure shall be subject to the appended claims.

What is claimed is:

1. An electric toothbrush, comprising a shell, a toothbrush head, a first spiral bevel gear, a second spiral bevel gear, and a drive motor, wherein the toothbrush head is connected with the second spiral bevel gear; the first spiral bevel gear and the second spiral bevel gear are in transmission connection; the first spiral bevel gear is arranged above the drive motor and is in transmission connection with the drive motor; a central axis of the first spiral bevel gear is perpendicular to a central axis of the second spiral bevel gear;
the drive motor has a stepped shaft connected to the first spiral bevel gear; the stepped shaft comprises a first shaft body, a second shaft body, and a third shaft body, the diameters of which are sequentially reduced from bottom to top; the third shaft body is in transmission connection with the first spiral bevel gear; a bearing connected to an inner wall of the shell is arranged in the shell; and the bearing is rotatably connected with the second shaft body of the stepped shaft.

2. The electric toothbrush according to claim 1, wherein the shell comprises a front toothbrush handle body and a rear toothbrush handle body; a front end part of the rear toothbrush handle body is connected to a rear end part of the front toothbrush handle body; the drive motor is connected to an inner wall of the rear toothbrush handle body; and an outer wall of the rear toothbrush handle body is connected with a control button for switching a rotating speed of the drive motor and/or controlling the drive motor to be turned on and turned off.

3. The electric toothbrush according to claim 2, wherein a lower end of the rear toothbrush handle body is connected with a socket body, and a battery for supplying power to the control button and the drive motor is arranged in the socket body or the rear toothbrush handle body.

4. The electric toothbrush according to claim 3, wherein the control button is connected with a control chip; the control button is in signal connection with the control chip; the control chip is arranged in the rear toothbrush handle body or the socket body; and the control chip is electrically connected with the battery.

5. The electric toothbrush according to claim 3, wherein the inside of the rear toothbrush handle body is connected with several indicator lamps for displaying gear positions of the drive motor; and the indicator lamps are in signal connection with the control chip and/or the control button.

6. The electric toothbrush according to claim 5, wherein the outer wall of the rear toothbrush handle body is connected with a protection plate; the height of the protection plate is greater than a distance between the two indicator lamps on the outermost side; and the protection plate is a transparent plate body.

7. The electric toothbrush according to claim 1, wherein the toothbrush head has a circular mounting surface which is connected with multiple layers of annularly distributed bristles.

8. The electric toothbrush according to claim 1, wherein the first shaft body, the second shaft body, and the third shaft body are integrated to form the stepped shaft.

9. The electric toothbrush according to claim 1, wherein the control chip is configured to be used for receiving an electric signal from the control button and switching the rotating speed of the drive motor and/or controlling the drive motor to be turned on and turned off.

10. The electric toothbrush according to claim 4, wherein the first spiral bevel gear and the second spiral bevel gear are both integrated by injection molding.
